(19) United States
(12) Patent Application Publication
(10) Pub. No.: US 2009/0226231 A1
(43) Pub. Date: Sep. 10, 2009

(54) POST-PROCESSING APPARATUS

(76) Inventor: Yasunobu OHKAWA, Nara (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/395,734

(22) Filed: Mar. 2, 2009

(30) Foreign Application Priority Data
Mar. 7, 2008 (JP) 2008-058223

(51) Int. Cl. G03G 15/00

(52) U.S. Cl. 399/410

(57) ABSTRACT

An image processing apparatus is provided which simultaneously processes a plurality of modes of image formation and reliably prevents post-processed recording sheets from falling off a tray. An image processing apparatus 1 is provided with a post-processing section 5 that performs stapling processing based on an input condition. The post-processing apparatus is provided with a tray 8 on which processed recording sheets are loaded. The tray 8 is provided downstream of the post-processing apparatus. The input conditions include printing conditions and stapling conditions. A control section 90 judges whether or not a maximum load capacity of the tray 8 is exceeded based on the input conditions. When the maximum load capacity is exceeded, the control section 90 stores a plurality of different input conditions in a list and informs the user of the list. The control section starts processing based on the input conditions selected by the user and loads printed recording sheets on the tray 8.

### BACKGROUND OF THE INVENTION

1. Field of the Invention

The present invention relates to a post-processing apparatus that performs post-processing on recording sheets.

2. Description of the Related Art

The development of post-processing apparatuses that perform post-processing on processed recording sheets has been underway in recent years. Examples of the processing function of such a post-processing apparatus include stapling processing, punching processing and bookbinding processing.

Post-processed recording sheets are loaded into a tray provided downstream of the post-processing apparatus. However, there is a problem that a desired number of post-processed recording sheets cannot be loaded into the tray and the recording sheets may fall off the tray depending on input conditions (number of sheets bound, number of staples, stapling positions, number of sheets ejected or the like).

Therefore, Japanese Patent Laid-Open No. 06-8666 discloses a post-processing apparatus that changes a stapling position for each bundle of recording sheets ejected and thereby reduces the bulk of the bundle of recording sheets.

However, since Japanese Patent Laid-Open No. 06-8666 is intended to reduce only the bulk of the bundle of recording sheets subjected to stapling processing, the user needs to check the stapling condition under which the bulk of the bundle of recording sheets can be reduced, which results in a problem that the setting time is extended.

It is an object of the present invention to provide a post-processing apparatus that reliably prevents recording sheets after post-processing from falling off the tray.

### SUMMARY OF THE INVENTION

In order to attain the above-described object, the present invention includes a post-processing section that performs stapling processing based on an input condition, a tray on which stapling processed recording sheets are placed and a control section that controls the post-processing section, wherein the control section sets a maximum load capacity within which the recording sheets will not fall off the tray according to the input condition, calculates a load capacity of the recording sheets from the input condition, judges whether or not the load capacity is equal to or greater than the maximum load capacity and changes the input condition when the load capacity is equal to or greater than the maximum load capacity.

The “input condition” refers to conditions including a printing condition, which is printing information for the image processing apparatus to form an image on a recording sheet and a stapling condition, which is stapling information for the post-processing apparatus to perform stapling processing. The “printing condition” refers to processing information such as recording sheet size information, recording sheet orientation information, information on the number of recording sheets on which an image is formed, basis weight information of the recording sheet, single-side/double-side printing information and N-up printing information. The “stapling condition” refers to stapling information such as information on the positions of staples with respect to the recording sheet, information on the orientation of staples with respect to the recording sheet and information on the number of recording sheets bound per set.

The post-processing section performs stapling processing based on the stapling condition included in the input condition. The processed recording sheets are ejected into the tray. In this case, the control section performs control such that the recording sheets are offset and loaded into the tray.

For the tray, a maximum load capacity of recording sheets that can be loaded is set. The load capacity varies based on various types of information such as the size of the recording sheet, orientation of the recording sheet, positions of staples with respect to the recording sheet, staple orientation with respect to the recording sheet and the number of recording sheets bundled together by staples.

The control section calculates the load capacity of recording sheets loaded into the tray from the input condition. The control section judges whether or not the calculated load capacity is equal to or greater than the maximum load capacity of the tray. When the load capacity of the recording sheets is equal to or greater than the maximum load capacity of the tray, the control section changes the input condition.

When changing the input condition, the control section creates different input conditions so that the largest possible number of recording sheets can be loaded on the tray. For example, the control section changes input conditions such as the positions of staples with respect to the recording sheet, staple orientation with respect to the recording sheet, number of recording sheets on which an image is formed, number of recording sheets bound per set, size of the recording sheet and orientation of the recording sheet.

The control section lists the changed input conditions and informs the user of the list. As the way of informing, for example, a display section for displaying input conditions, provided to the post-processing apparatus, is used, and the control section causes the display section to display the list of the changed input conditions. Alternatively, enabled to communicate with an outside terminal, the control section informs of the list of the changed input conditions the outside terminal to which the input condition is inputted.

The user selects a desired input condition from the list. The control section changes the setting to the input condition selected from the list. The image formation section performs processing based on the changed input condition.

As described above, the present invention judges whether or not processed recording sheets can be loaded on the tray based on the input condition and informs the user of a list of new input conditions when the number of processed recording sheets exceeds the maximum load capacity. This allows the user to select a desired input condition, load the recording sheets on the tray most effectively and reduce the frequency with which the processed recording sheets are ejected from the tray. Therefore, it is possible to improve operating efficiency and reliably prevent processed recording sheets from falling off.

### BRIEF DESCRIPTION OF THE DRAWINGS

FIG. 1 shows a schematic configuration of an image processing apparatus according to the present invention;

FIG. 2 shows a schematic configuration of a post-processing section and a tray;

FIG. 3 is a perspective view showing the post-processing section and tray and is a perspective view showing a situation in which the tray is contracted and elevated and the cover is closed;

FIG. 4 is a perspective view showing the tray in a lowered position and post-processing section;

FIG. 5 is a perspective view showing the tray in a stretched condition and post-processing section;

FIG. 6 is a perspective view showing the post-processing section and tray when the cover is closed;

FIG. 7 is a function block diagram showing main parts of the control section;

FIG. 8 shows recording sheets loaded on the tray; (a) showing the recording sheets normally loaded and (b) showing the recording sheets offset and loaded;

FIG. 9 shows a management table; (a) showing the stapling positions set to central 2 points/front 1 point (parallel) of a recording sheet and (b) showing the stapling positions set to central 2 points of a recording sheet;

FIG. 10 shows a management table; (a) showing the stapling positions set to back 1 point (parallel)/front 1 point (parallel) of the recording sheet and (b) showing the stapling position set to back 1 point (parallel) of the recording sheet;

FIG. 11 shows a management table; (a) showing the stapling position set to front 1 point (parallel) of the recording sheet and (b) showing the stapling positions set to back 1 point (diagonal)/front 1 point (parallel) of the recording sheet;

FIG. 12 shows a management table; (a) showing the stapling positions set to back 1 point (diagonal)/back 1 point (parallel) of the recording sheet and (b) showing the stapling position set to back 1 point (diagonal) of the recording sheet;

FIG. 13 shows a relationship between staples and a maximum load capacity when recording sheets are loaded on the tray;

FIG. 14 shows a general view of the operation panel where a message is displayed on the display section;

FIG. 15 shows a detailed view of the screen of the operation panel showing an example where a message is displayed on the display section;

FIG. 16 is a flowchart showing processing operations;

FIG. 17 is a flowchart showing processing operations following the flow in FIG. 16;

FIG. 18 is a flowchart showing processing operations following the flow in FIG. 17;

FIG. 19 is a general view of the operation panel where a message is displayed on the display section; and

FIG. 20 shows a detailed view of the screen of the operation panel showing an example where an input mode of inputting the number of required copies is displayed on the display section.

### DETAILED DESCRIPTION OF THE PREFERRED EMBODIMENTS

Hereinafter, the post-processing apparatus of the present invention will be explained in detail. For convenience of explanation, a case will be explained where the post-processing apparatus is mounted in a multifunctional periphery, which is an image processing apparatus 1 having a copy mode, printer mode, scanner mode, facsimile mode and filing mode.

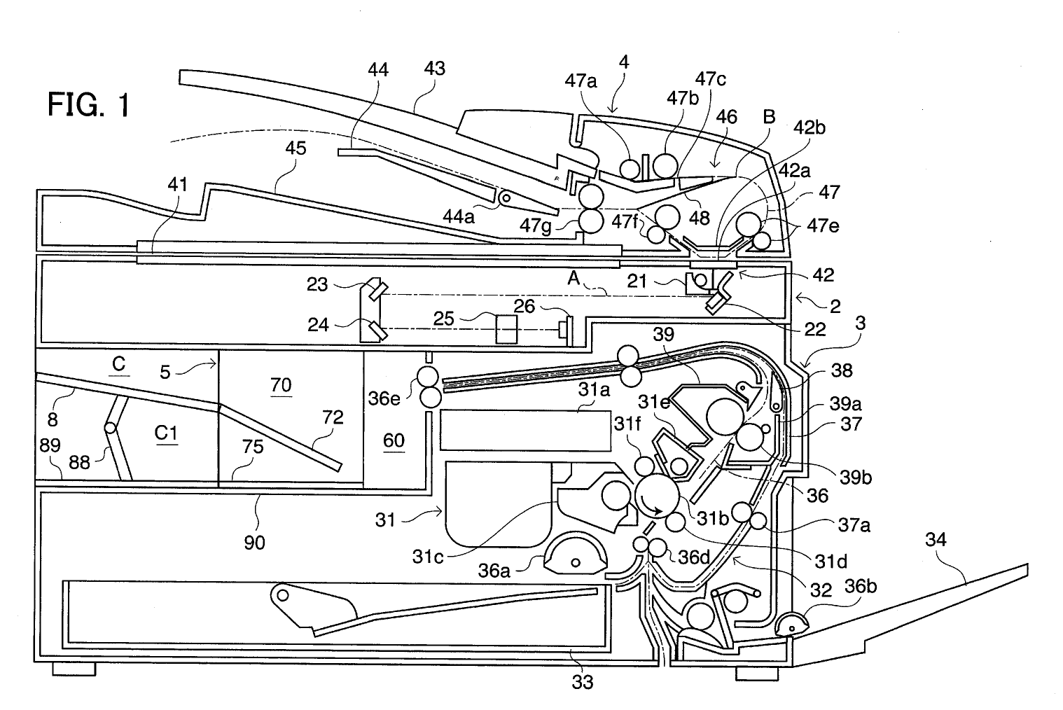

The image processing apparatus 1 is intended to form an image on a recording sheet (including a recording medium such as OHP) and provided with a scanner section 2, an image formation section 3, an automatic document feeding section 4 and a post-processing section 5 as shown in FIG. 1. Each mode provided for the image processing apparatus 1 can be selected by the user as appropriate. For convenience of explanation, parts other than the post-processing section 5 and a tray 8 of the image processing apparatus 1 will be referred to as “apparatus body.”

Hereinafter, the respective sections of the image processing apparatus 1 will be explained and then operations during stapling processing according to the present invention will be explained.

### [Configuration of Scanner Section 2]

The scanner section 2 is a section that reads an image of a document placed on a document table 41 made of transparent platen glass or images of documents fed one by one from the automatic document feeding section 4 and creates document image data.

The scanner section 2 is provided with a light source for exposure 21, a plurality of reflectors 22, 23 and 24, an image-forming lens 25 and a charge coupled device (CCD) 26.

The light source for exposure 21 is intended to irradiate light onto a document placed on the document table 41 of the automatic document feeding section 4 or a document carried through the automatic document feeding section 4.

The reflectors 22, 23 and 24 cause reflected light from the document to reflect leftward and then reflect downward in FIG. 1 as the optical path is shown by a single-dot dashed line A in FIG. 1. The reflectors 22, 23 and 24 then reflect light rightward in FIG. 1 so that light is directed to the image-forming lens 25.

The document image reading operation includes the following two cases. A case where a document placed on the document table 41 is read (when used as “sheet fixing method”) and a case where a document carried through the automatic document feeding section 4 is read (when used as “sheet transfer method”).

When the document placed on the document table 41 is read, the light source for exposure 21 and the respective reflectors 22, 23 and 24 scan in a horizontal direction along the document table 41 and read the image of the entire document.

On the other hand, when the document carried through the automatic document feeding section 4 is read, the light source for exposure 21 and the respective reflectors 22, 23 and 24 read the image of the document when the document passes through a document reading section 42 of the automatic document feeding section 4, which is fixed at a position shown in FIG. 1 and will be described later.

Light that is reflected by the respective reflectors 22, 23 and 24 and has passed through the image-forming lens 25 is guided to the charge coupled device 26 and the reflected light is converted to an electric signal (document image data) at this charge coupled device 26.

### [Configuration of Image Formation Section 3]

The image formation section 3 is provided with an image formation system 31 as a printing section and a sheet transfer system 32 as a transfer section.

The image formation system 31 is provided with a laser scanning unit 31a and a photoreceptor drum 31b as a drum type image supporter.

The laser scanning unit 31a is intended to irradiate a laser beam, based on the document image data converted by the charge coupled device 26 or image data inputted from an outside terminal apparatus, onto the surface of the photoreceptor drum 31b.

The photoreceptor drum 31b rotates in the direction shown by an arrow in FIG. 1 and an electrostatic latent image is formed on the surface thereof by being irradiated with the laser beam from the laser scanning unit 31a.

Around the outer perimeter of the photoreceptor drum 31b, there are provided not only a laser scanning unit 31a but also a developer unit (developing mechanism) 31c, a transfer unit (transfer mechanism) (not shown) having a transfer roller 31d, a cleaning unit (cleaning mechanism) 31e, a static eliminator (not shown), and a charge unit (charge mechanism) (not shown) having a charge roller 31f in that order in the circumferential direction.

The developer unit 31cis intended to develop the electrostatic latent image formed on the surface of the photoreceptor drum 31b into a visual image with toner (visualizing material). The transfer roller 31d transfers the toner image formed on the surface of the photoreceptor drum 31b to a recording sheet as a recording medium.

The cleaning unit 31e is intended to remove the toner remaining on the surface of the photoreceptor drum 31b after the toner transfer. The static eliminator is intended to remove the remaining charge on the surface of the photoreceptor drum 31b. The charge roller 31f is intended to charge the surface of the photoreceptor drum 31b to a predetermined potential before the electrostatic latent image is formed.

When an image is formed on a recording sheet, the charge roller 31f charges the surface of the photoreceptor drum 31b to a predetermined potential and the laser scanning unit 31a irradiates a laser beam based on the document image data onto the surface of the photoreceptor drum 31b. The developer unit 31cdevelops a visible image by means of toner on the surface of the photoreceptor drum 31b and the transfer roller 31d transfers the toner image on the recording sheet. After that, the toner remaining on the surface of the photoreceptor drum 31b is removed by the cleaning unit 31e and the remaining charge on the surface of the photoreceptor drum 31b is removed by the static eliminator.

This completes one cycle of image forming operation (printing operation) on the recording sheet. Repetition of this cycle allows images to be consecutively formed on a plurality of recording sheets.

The sheet transfer system 32 transfers recording sheets stored in a paper cassette 33 as a sheet feeding section or recording sheets placed on a manual sheet feed tray 34 one by one, causes the image formation system 31 to form an image and ejects the recording sheets on which images have been formed via the tray 8 and the post-processing section 5 which will be described later.

The tray 8, which will be described later, is provided above the paper cassette 33 and below the scanner section 2.

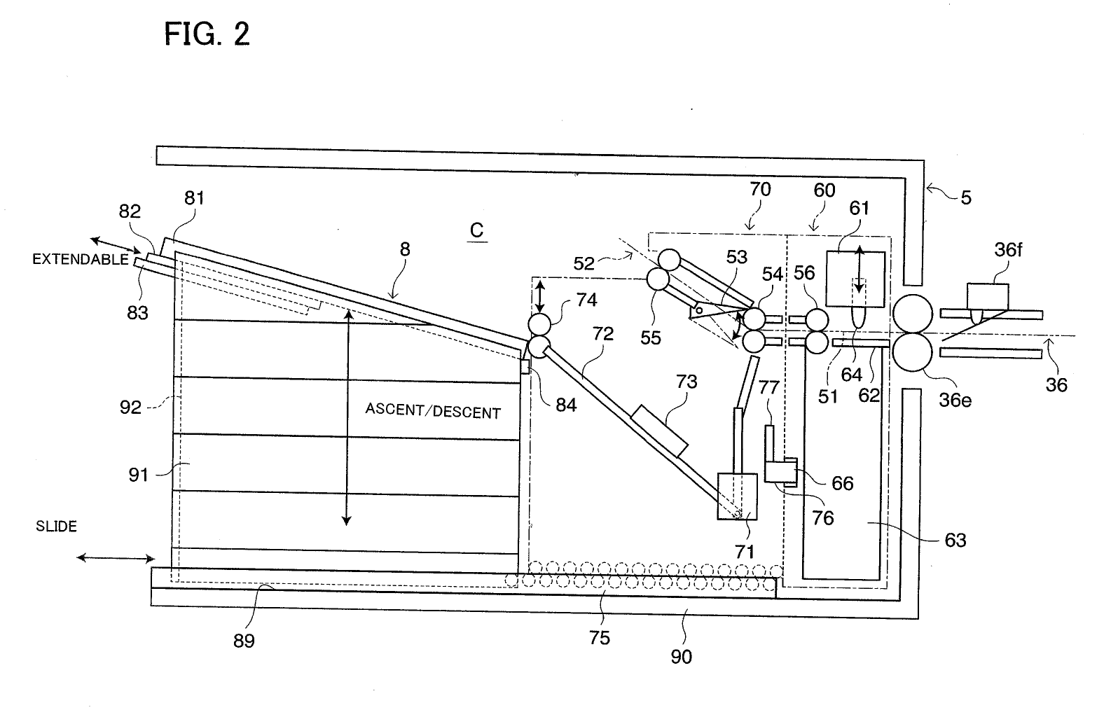

The sheet transfer system 32 is provided with a main transfer path 36 and an inverted transfer path 37 in the apparatus body, and a main transfer path 51 and a switchback transfer path 52 in the post-processing section 5 shown in FIG. 2.

The main transfer path 36 in the apparatus body is connected to the main transfer path 51 in the post-processing section 5 at a sheet ejection roller 36e of the apparatus body as a boundary. The main transfer path 51 and the switchback transfer path 52 of the post-processing section 5 will be described later. In the image processing apparatus 1, the recording sheet is transferred through the sheet transfer system 32 according to a so-called central reference. That is, the recording sheet is transferred using the central position in the width direction thereof (direction orthogonal to the transfer direction of the recording sheet) as a reference.

One end of the main transfer path 36 of the apparatus body is bifurcated. One branch end faces the sheet ejection side of the paper cassette 33. The other branch end faces the sheet ejection side of the manual sheet feed tray 34. Furthermore, the other end of the main transfer path 36 faces a punching unit 60 of the post-processing section 5.

The one end of the inverted transfer path 37 is connected to the main transfer path 36 upstream (lower part in FIG. 1) of the position where the transfer roller 31d is disposed. The other end of the inverted transfer path 37 is connected to the main transfer path 36 downstream (upper part in FIG. 1) of the position where the transfer roller 31d is disposed.

A pickup roller 36a having a semicircular section is disposed at one branch end of the main transfer path 36 (part facing the sheet ejection side of the paper cassette 33). The rotation of this pickup roller 36a allows recording sheets held in the paper cassette 33 to be intermittently fed one by one to the main transfer path 36.

Likewise, a pickup roller 36b having a semicircular section is disposed at the other branch end (the part facing the sheet ejection side of the manual sheet feed tray 34) of the main transfer path 36. The rotation of this pickup roller 36b allows recording sheets placed on the manual sheet feed tray 34 to be intermittently fed one by one to the main transfer path 36.

A resist roller 36d is disposed upstream of the position where the transfer roller 31d is disposed in this main transfer path 36. This resist roller 36d is intended to transfer a recording sheet while positioning between the toner image on the surface of the photoreceptor drum 31b and the recording sheet.

A fixing unit 39 provided with a pair of heating roller 39a and pressure roller 39b for fixing the toner image transferred to the recording sheet by heat is disposed downstream of the position where the transfer roller 31d is disposed in the main transfer path 36. Furthermore, the sheet ejection roller 36e for ejecting recording sheets to the post-processing section 5 is disposed at a downstream end of the main transfer path 36 on the boundary with the main transfer path 51 of the post-processing section 5.

A branch lug 38 is disposed at a connection position at an upstream end of the inverted transfer path 37 facing the main transfer path 36. The branch lug 38 is rotatable around a horizontal axis between a first position (position shown by a solid line) in FIG. 1 and a second position where the branch lug 38 rotates counterclockwise in FIG. 1 from this first position to release the inverted transfer path 37.

When the branch lug 38 is at the first position, the recording sheet is transferred to the main transfer path 51 of the post-processing section 5. When the branch lug 38 is at the second position, the recording sheet can be supplied to the inverted transfer path 37.

A transfer roller 37a is disposed in the inverted transfer path 37. When a recording sheet switched back in the switchback transfer path 52 of the post-processing section 5 is supplied to the inverted transfer path 37, the recording sheet is transferred by this transfer roller 37a, the recording sheet is introduced to the main transfer path 36 upstream of the resist roller 36d and transferred again in the main transfer path 36 toward the transfer roller 31d. That is, images can be formed on the back of the recording sheet.

### [Configuration of Automatic Document Feeding Section 4]

The automatic document feeding section 4 is configured as an automatic double-side document transfer apparatus. The automatic document feeding section 4 can be used as a sheet transfer method. The automatic document feeding section 4 is provided with a document tray 43 as a document loading section, an intermediate tray 44, a document ejection tray 45 as a document ejection section and a document transfer system 46 that transfers a document between the trays 43, 44 and 45.

The document transfer system 46 is intended to transfer the document placed on the document tray 43 to the intermediate tray 44 or the document ejection tray 45 via the document reading section 42. The document transfer system 46 is provided with a main transfer path 47 and a sub-transfer path 48 to supply the document on the intermediate tray 44 to the main transfer path 47.

A document pickup roller 47a and a feeding roller 47b are disposed at an upstream end of the main transfer path 47 (part facing the sheet ejection side of the document tray 43). A feeding plate 47c is disposed below the feeding roller 47b. One of the documents on the document tray 43 passes between the feeding roller 47b and the feeding plate 47c and is fed to the main transfer path 47 as the document pickup roller 47a rotates.

PS rollers 47e and 47e are disposed downstream of a part where the main transfer path 47 and the sub-transfer path 48 merge (part B in FIG. 1). The PS rollers 47e and 47e are intended to adjust the end of the document and image reading timing of the scanner section 2 and supply the document to the document reading section 42. That is, the PS rollers 47e and 47e are designed to temporarily stop the transfer of the document when the document has been supplied, adjust the timing and supply the document to the document reading section 42.

The document reading section 42 is provided with a platen glass 42a and a document holding plate 42b. The document reading section 42 is designed to allow light from the light source for exposure 21 to pass through the platen glass 42a and irradiate the document when the document supplied from the PS rollers 47e and 47e passes between the platen glass 42a and the document holding plate 42b. In this case, the scanner section 2 acquires document image data.

A biasing force by a coil spring (not shown) is applied to the back (top surface) of the document holding plate 42b. This causes the document holding plate 42b to contact the platen glass 42a with a predetermined pressure and prevents the document from floating from the platen glass 42a when the document passes through the document reading section 42.

A transfer roller 47f and a document ejection roller 47g are provided downstream of the platen glass 42a. The document having passed over the platen glass 42a is designed to pass through the transfer roller 47f and document ejection roller 47g and finally to be ejected to the intermediate tray 44 or document ejection tray 45.

An intermediate tray oscillation plate 44a is disposed between the document ejection roller 47g and the intermediate tray 44. This intermediate tray oscillation plate 44a can oscillate around the end of the intermediate tray 44 between a position 1 (position shown by a solid line) and a position 2 flipped up from this position 1 in FIG. 1.

When the intermediate tray oscillation plate 44a is located at the position 2, the document ejected from the document ejection roller 47g is collected into the document ejection tray 45. On the other hand, when the intermediate tray oscillation plate 44a is located at the position 1, the document ejected from the document ejection roller 47g is designed to be ejected into the intermediate tray 44.

When ejected into the intermediate tray 44, the end of the document is sandwiched between the document ejection rollers 47g and 47g and when the document ejection roller 47g rotates backward in this condition, the document is supplied to the sub-transfer path 48, and sent out to the main transfer path 47 again via this sub-transfer path 48. The backward rotation operation of this document ejection roller 47g is performed by adjusting the sending of the document to the main transfer path 47 and image reading timing. This allows the document reading section 42 to read the image of the back of the document.

### [Configuration of Post-Processing Section 5 and Tray Section 8]

The post-processing section 5 is intended to enable sheet post-processing on a plurality of recording sheets ejected from the apparatus body after completion of printing processing such as punching processing and stapling processing. Such sheet post-processing by the post-processing section 5 is performed when there is a post-processing request as an input condition at the time of a printing request, which will be described later. When there is no post-processing request, sheets are ejected without performing sheet post-processing.

According to the present embodiment, the post-processing section 5 and tray 8 are not provided outside the apparatus body of the image processing apparatus 1 but using a space C formed by the apparatus body. More specifically, in the apparatus body of the image processing apparatus 1, the paper cassette 33, image formation section 3 (image formation system 31) and scanner section 2 are arranged in a channel shape and the post-processing section 5 and tray 8 are provided in the space C inside this channel shape formed by this apparatus body.

This allows the post-processing section 5 and tray 8 to be fitted in a limited space in the image processing apparatus 1 and allows a plurality of types of post-processing on recording sheets to be performed. It is also possible to reduce the area occupied by the image processing apparatus 1 provided with the post-processing section 5 and realize space saving.

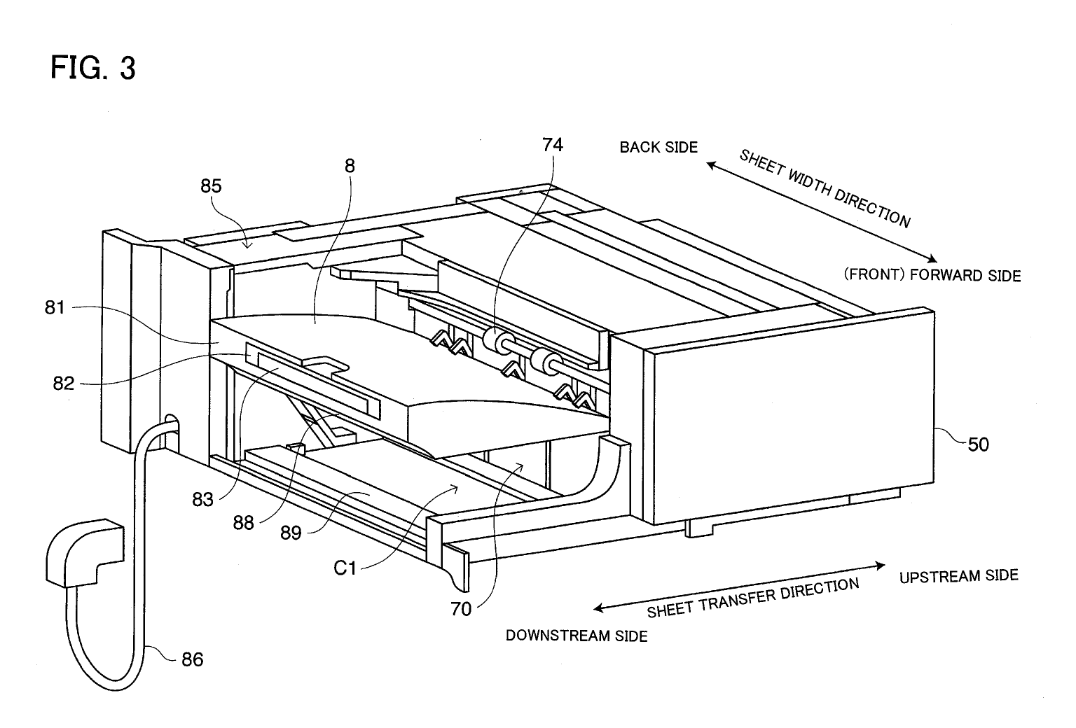

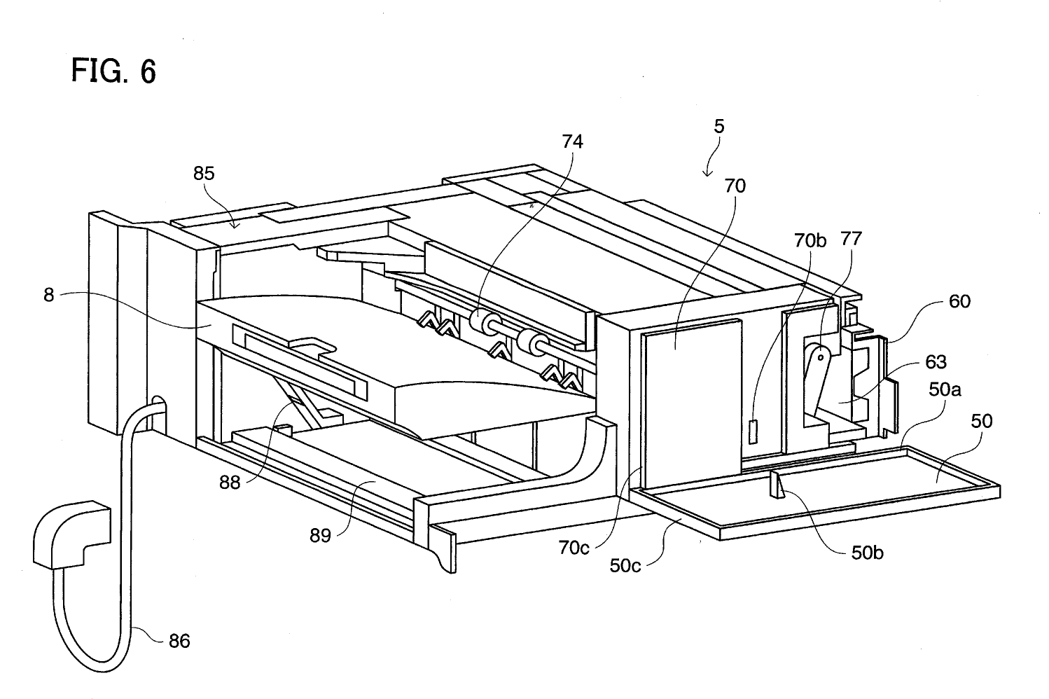

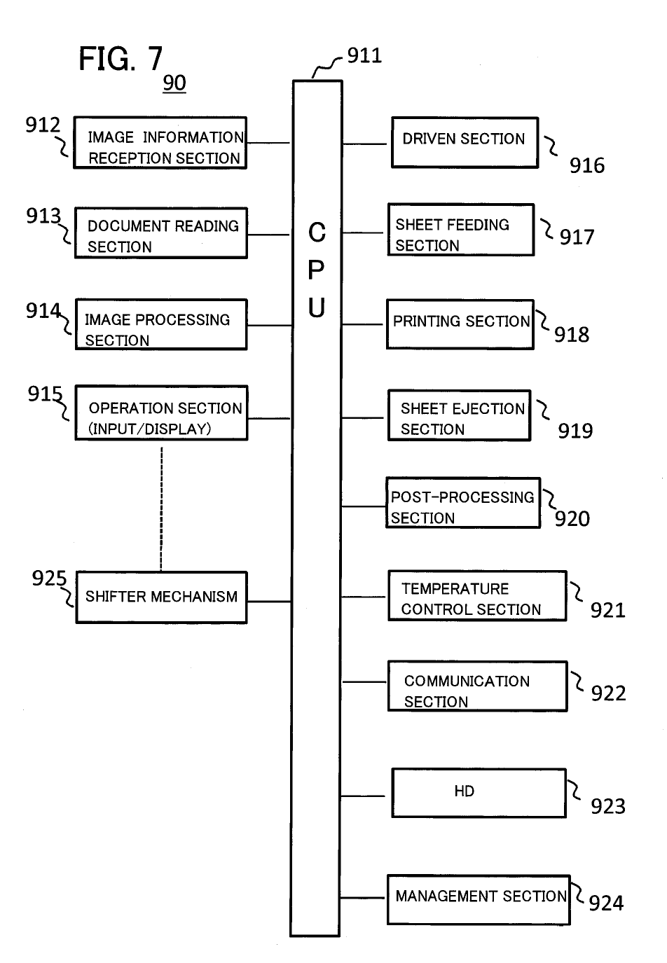

Hereinafter, the post-processing section 5 and tray 8 will be explained in detail using FIG. 2 to FIG. 6. Note that the transfer direction of a recording sheet (direction shown in FIG. 3) will be referred to as “sheet transfer direction” and the width direction of the recording sheet orthogonal to this (direction shown in FIG. 3) will be referred to as “sheet width direction.”

The post-processing section 5 is arranged downstream of the sheet ejection roller 36e of the apparatus body as shown in FIG. 2. The post-processing section 5 is provided with the punching unit 60 having a punch hole punching function and a stapling unit 70 having a stapling function as the post-processing apparatus.

The front (surface on the forward side) of the post-processing section 5 is covered with a cover 50 which can be opened/closed. The punching unit 60 is disposed upstream and the stapling unit 70 is disposed downstream of the post-processing section 5.

The tray 8 is provided downstream of the post-processing section 5. A recording sheet ejected from the sheet ejection roller 36e is ejected into the tray 8 via the punching unit 60 and stapling unit 70. When the stapling unit 70 of the post-processing section 5 performs stapling processing, this tray 8 is used as a sheet recipient for stapling processing.

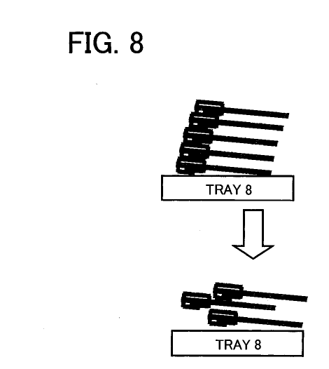

The tray 8 can be provided with a shifter mechanism. The “shifter mechanism” is intended to make variable the speed of sheet ejection when recording sheets are ejected into the tray 8. That is, the shifter mechanism is intended to perform offset processing on the recording sheet ejected into the tray 8 per set during sheet ejection. The details are described in Japanese Patent Laid-Open No. 2006-8370 and Japanese Patent Laid-Open No. 2004-307137 (see FIG. 8).

### [Configuration of Punching Unit 60]

The punching unit 60 is intended to perform processing of punch hole punching (punching processing) on a recording sheet ejected from the sheet ejection roller 36e.

The punching unit 60 is provided with at least a punching mechanical section 61, a guide plate 62 and a punch cutting storage box 63. The main transfer path 51 is formed in the punching unit 60 as the sheet transfer system 32. The punching unit 60 is provided with a transfer roller 56 at some midpoint of the main transfer path 51. Unlike the stapling unit 70 which will be described later, the punching unit 60 is fixed to the apparatus body.

When there is a request for punching processing as an input condition at the time of a printing request, the punching unit 60 stops the recording sheet transferred to the punching unit 60 on the guide plate 62 and makes punch holes one sheet at a time through the punching mechanical section 61. In this case, punch holes are made at positions determined based on the printing sheet size.

The punching mechanical section 61 is disposed at the top of the punching unit 60. The punching mechanical section 61 is provided with cores 64 of a diameter that matches the diameter of punch holes at two locations at a predetermined distance in the sheet width direction.

The cores 64 are designed to be able to ascend/descend in the vertical direction and when the cores 64 descend, punch holes are made in the recording sheet. Furthermore, the cores 64 are also designed to be movable to and fro in the directions along the sheet transfer direction and the sheet width direction so as to allow positioning when performing punching processing, as will be described later.

The guide plate 62 is disposed under the punching mechanical section 61. Openings corresponding to the predetermined positions where punch holes are made are formed in the guide plate 62.

The punch cutting storage box 63 is disposed below the punching unit 60 and the punch cutting storage box 63 collects punch cuttings produced through the punching processing. The punch cutting storage box 63 is designed to be slidable along the sheet width direction so that it can be pulled out forward when the cover 50 is opened as will be described later. This allows punch cuttings stored in the punch cutting storage box 63 to be removed.

When the punching unit 60 performs the punching processing, the cores 64 of the punching mechanical section 61 are designed to move to the positions corresponding to the positions determined based on the above-described printing sheet size.

In addition, inching of the cores 64 of the punching mechanical section 61 of the punching unit 60 are designed to be fine-tuned so as to allow punch holes to be exactly made at positions determined based on the above-described printing sheet size, but explanations of this fine-tuned inching will be omitted.

### [Configuration of Stapling Unit 70]

The stapling unit 70 is intended to perform stapling processing on a recording sheet transferred from the punching unit 60 on the upstream side. The stapling unit 70 is designed to be slidable in the sheet transfer direction when the cover 50 is lifted forward. Furthermore, the stapling unit 70 is designed to be detachable from the punching unit 60 disposed upstream of the stapling unit 70, as will be described later.

The stapling unit 70 is provided with at least a stapling mechanical section 71, a stapling table 72, a matching plate 73 and a sheet ejection roller 74. The main transfer path 51 and the switchback transfer path 52 are formed in the stapling unit 70 as the sheet transfer system 32.

The stapling unit 70 is provided with a branch lug 53 that switches the direction in which recording sheets are guided and a sheet ejection roller 54 that ejects the sheets onto the stapling table 72 at the position of connection between the downstream side of the main transfer path 51 and the upstream side of the switchback transfer path 52. A switchback roller 55 is provided downstream of the switchback transfer path 52.

When there is a request for stapling processing as an input condition at the time of a printing request, the stapling unit 70 performs stapling processing on a predetermined number of recording sheets loaded on the stapling table 72 through the stapling mechanical section 71. In this case, stapling processing is applied at positions determined based on the size of a recording sheet to be printed and a desired stapling position.

The “desired stapling position” refers to a position where the user wants stapling processing to be performed, for example, one stapling position at the top left corner or two stapling positions at the left end of the recording sheet and so on.

The stapling mechanical section 71 is disposed under the sheet ejection roller 54 and intended to bind the an end (user's desired end) of the recording sheet loaded on the stapling table 72 with staples. The stapling mechanical section 71 is configured to be movable to and fro along the sheet width direction and can apply stapling processing at positions determined based on the size of a recording sheet to be printed and a desired stapling position.

When performing stapling processing using the stapling unit 70, the stapling mechanical section 71 is moved to a position corresponding to the position determined based on the size of the recording sheet to be printed and a desired stapling position.

The stapling table 72 is intended for placing recording sheets ejected from the sheet ejection roller 54 and serves as a processing table for stapling processing by the stapling mechanical section 71. The stapling table 72 is disposed with its downstream side in the sheet transfer direction inclined upward. When stapling processing is performed, recording sheets ejected from the sheet ejection roller 54 slide down under their own weights along the inclination of the stapling table 72 toward the upstream side in the sheet transfer direction. On the other hand, when stapling processing is not performed, recording sheets are ejected from the sheet ejection roller 74 to the tray 8.

The matching plates 73 are disposed so as to face each other on both sides in the sheet width direction on the top surface of the stapling table 72 (surface onto which recording sheets are ejected). The pair of matching plates 73 are designed to be movable to and fro along the sheet width direction. When stapling processing is performed by the stapling unit 70, the sheet width direction is adjusted for each recording sheet ejected onto the stapling table 72 by moving the matching plates 73 in the sheet width direction.

In this case, the matching plates 73 are moved according to the movable width determined based on the size of the recording sheets to be printed. The pair of matching plates 73 can be moved to and fro by, for example, a rack-and-pinion mechanism.

### [Configuration of Tray 8]

The tray 8 is provided together with the post-processing section 5 in the inner channel shaped space C formed by the apparatus body of the image processing apparatus 1. Recording sheets subjected to post-processing such as punching processing and stapling processing by the post-processing section 5 are ejected into the tray 8. The tray 8 is designed to be extendable along the sheet transfer direction (sheet ejection direction of recording sheets). The tray 8 is designed to be movable upward or downward. The tray 8 is designed to be slidable in the apparatus body.

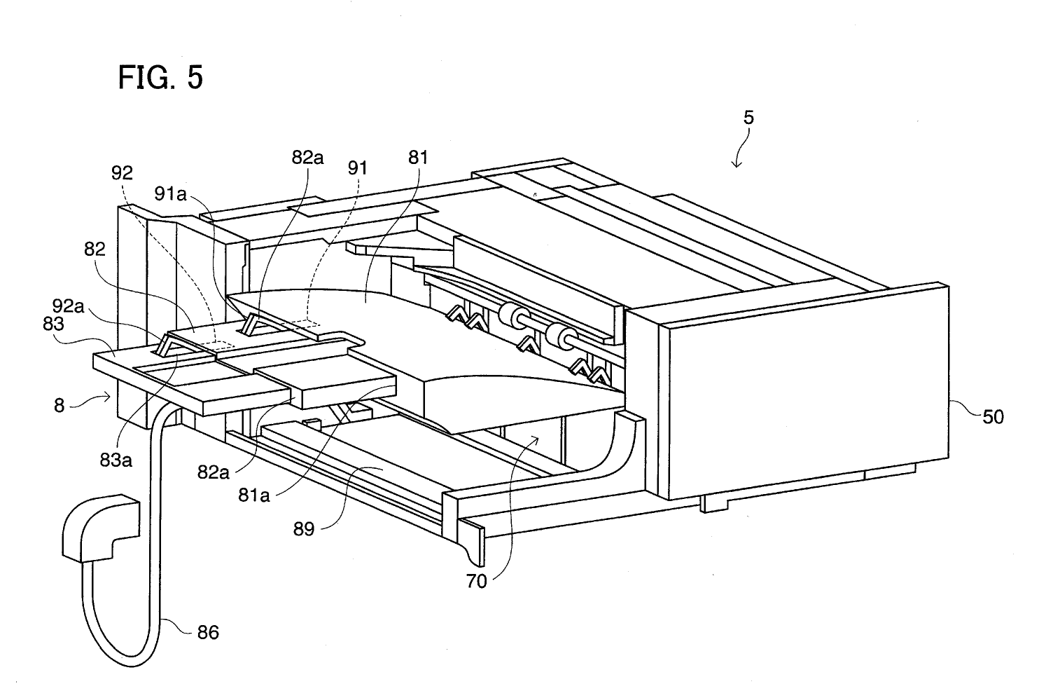

As shown in FIG. 3 and FIG. 5, the tray 8 is formed as a tray extendable in 1 to 3 stages in the sheet transfer direction. According to the present embodiment, the tray 8 is configured such that the user can manually extend or contract it in the sheet transfer direction according to the size of recording sheets to be printed.

The tray 8 is provided with a first tray 81, a second tray 82 and a third tray 83.

The first tray 81 is the largest tray. The first tray 81 is located closest to the post-processing section 5. The first tray 81 is formed to a length that will not protrude from the side (side wall) of the image processing apparatus 1. The first tray 81 is formed integral with the apparatus body and has a structure immobile in the sheet transfer direction.

The second tray 82 is a tray of intermediate size. The second tray 82 is housed in a housing part 81a formed in the first tray 81. The second tray 82 is designed to be movable to and fro in the sheet transfer direction.

The third tray 83 is a tray of smallest size. The third tray 83 is housed in a housing part 82a formed in the second tray 82. The third tray 83 is designed to be movable to and fro in the sheet transfer direction.

As shown in FIG. 3, when the tray 8 is contracted to only one stage, the length of the tray 8 in the sheet transfer direction becomes minimum. More specifically, the entire third tray 83 is housed in the second tray 82 and the entire second tray 82 is housed in the first tray 81. The length of the tray 8 in the sheet transfer direction is equal to the length of the first tray 81 in the sheet transfer direction and is such a length that will not protrude from the side of the image processing apparatus 1.

This prevents the tray 8 in the fully contracted state from protruding from the apparatus body and thereby allows the tray 8 to be housed in the space of the apparatus body when the image processing apparatus 1 is not used.

On the contrary, when the tray 8 is made to extend in three stages as shown in FIG. 5, the length of the tray 8 in the sheet transfer direction becomes maximum. More specifically, the second tray 82 protrudes from the first tray 81 to a maximum and the third tray 83 protrudes from this second tray 82 to a maximum extent. The length of the tray 8 in the sheet transfer direction is longer than a maximum printable size in the image processing apparatus 1, for example, longer than the length of a recording sheet in A3 horizontal size.

When the tray 8 is extended to a maximum length, this allows even a recording sheet in a maximum printable size (A3 horizontal size) to be stably loaded. As will be described later, the tray 8 is slidable together with the stapling unit 70, but even if the tray 8 is made to slide with the recording sheets loaded, the recording sheets will not fall off the tray 8.

Since the tray 8 is designed to be extendable in the sheet transfer direction, the tray 8 can be adjusted to an optimal length according to the size of the recording sheet to be printed.

The opening 82a is formed on the top surface of the second tray 82 in the vicinity of its proximal end and an operating lug 91a of a first sheet detection sensor 91 is disposed so as to protrude upward from the opening 82a.

The operating lug 91a is always biased so as to protrude upward and when the second tray 82 is housed in the first tray 81, the operating lug 91a is pressed downward by the top surface of the inner wall of the first tray 81. When the second tray 82 is fully pulled out from the first tray 81 (see FIG. 5), the operating lug 91a rotates and is restored to the normal position protruding upward from the opening 82a.

According to the present embodiment, the first sheet detection sensor 91 is designed to turn “OFF” when the operating lug 91a protrudes upward and turn “ON” when the operating lug 91a is pressed downward by the top surface of the inner wall of the first tray 81.

Likewise, an opening 83a is formed on the top surface of the third tray 83 in the vicinity of its proximal end and an operating lug 92a of a second sheet detection sensor 92 is disposed so as to protrude upward from the opening 83a. This operating lug 92a is always biased so as to protrude upward and when the third tray 83 is housed in the second tray 82, the operating lug 92a is pressed downward by the top surface of the inner wall of the second tray 82.

When the third tray 83 is fully pulled out from the second tray 8 (see FIG. 5), the operating lug 92a rotates and is restored to the normal position protruding upward from the opening 83a.

According to the present embodiment, the second sheet detection sensor 92 is designed to turn “OFF” when the operating lug 92a protrudes upward and turn “ON” when the operating lug 92a is pressed downward by the top surface of the inner wall of the second tray 82. That is, the first sheet detection sensor 91 and second sheet detection sensor 92 are “OFF” when the respective trays 82 and 83 are pulled out, and in this condition, when recording sheets after printing are ejected and loaded into the respective trays 82 and 83, the operating lugs 91a and 92a are pressed downward by the loaded recording sheets, which causes the first sheet detection sensor 91 and second sheet detection sensor 92 to turn “ON.” The first sheet detection sensor 91 and second sheet detection sensor 92 are designed to turn “OFF” again when the user removes the recording sheets after printing from the tray 8. This makes it possible to detect whether or not there are recording sheets on the tray 8.

These first and second sheet detection sensors 91 and 92 may also be used as extension detection sensors that detect whether or not the second tray 82 and the third tray 83 are pulled out before printing starts.

That is, when the first sheet detection sensor 91 is “ON” before printing starts, it is possible to judge that the second tray 82 has not been pulled out from the first tray 81, and when the first sheet detection sensor 91 is “OFF,” it is possible to judge that the second tray 82 has been pulled out from the first tray 81. Furthermore, when the second sheet detection sensor 92 is “ON” before printing starts, it is possible to judge that the third tray 83 has not been pulled out from the second tray 82, and when the second sheet detection sensor 92 is “OFF,” it is possible to judge that the third tray 83 has been pulled out from the second tray 82.

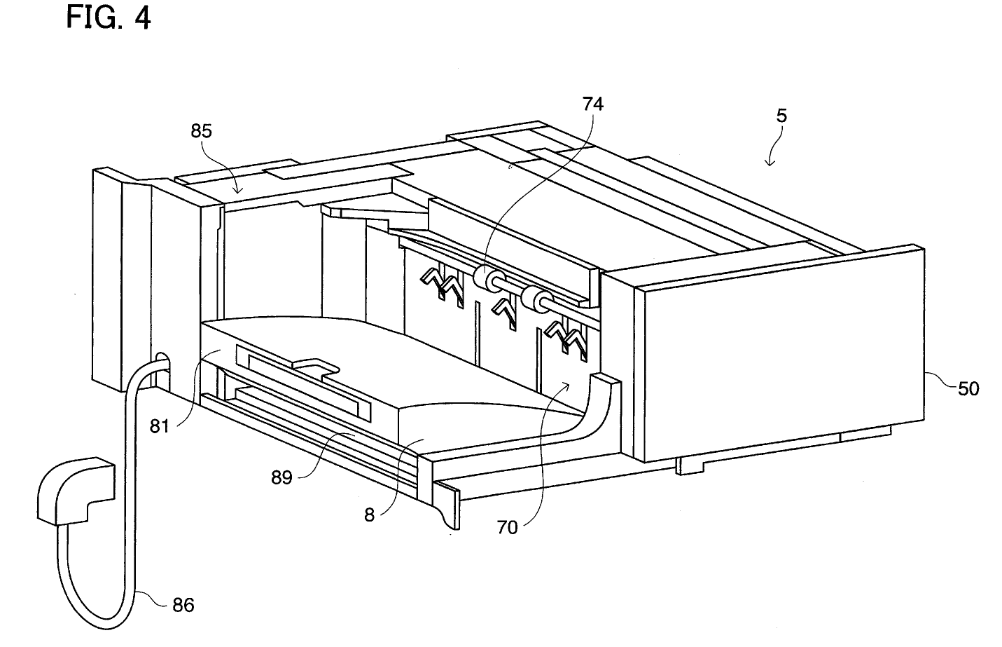

The tray 8 is formed as a tray that can move upward or downward as shown in FIG. 3 and FIG. 4. In this example, the tray 8 is configured to move upward or downward according to the amount (number) of recording sheets loaded.

The amount of recording sheets ejected into the tray 8 is detected by an upper limit sensor 84 provided in the vicinity of the lower sheet ejection roller 74. This upper limit sensor 84 is provided as a contact type sensor. When the top surface of the recording sheets loaded on the tray 8 reaches a predetermined height, the upper limit sensor 84 turns “ON.” This makes it possible to detect that the tray 8 is full. When the tray 8 is detected to be full, the tray 8 is lowered by a predetermined distance. With the descent of the tray 8, the upper limit sensor 84 turns “OFF.” The amount of recording sheets loaded on the tray 8 is detected through the switching between “ON/OFF” of the upper limit sensor 84.

According to the present embodiment, the highest position of the tray 8 (see FIG. 3) is assumed to be a home position of the tray 8 and the upstream end of the tray 8 is disposed right below the sheet ejection roller 74. The tray 8 is made to gradually descend as the amount of recording sheets loaded increases. An optical sensor may be provided as the upper limit sensor 84.

The tray 8 is provided so as to be extendable, and during its ascent or descent, when the first tray 81 ascends or descends, the second tray 82 and the third tray 83 are configured to ascend or descend together with this first tray 81.

The ascent or descent of the first tray 81 is performed, for example, as follows. A drive section 85 for driving the first tray 8 to move upward or downward is provided at the back of the first tray 81. A drive belt (not shown) is accommodated in this drive section 85. The drive belt can be driven by a drive power supply (not shown) connected by a wire 86. A support member for supporting the end of the first tray 81 is connected to the drive section 85. The support member is provided so as to perform reciprocating motion in the vertical direction by driving the drive belt.

The power of the drive belt of the drive section 85 is transmitted to the first tray 81 via such a support member and this causes the first tray 81 to ascend or descend.

An arm 88 for supporting the first tray 81 is provided below the first tray 81. The arm 88 is disposed between the first tray 81 and a bottom part 89. The arm 88 is bent into an L-shape and the bending angle is made variable. This bending angle of the arm 88 varies according to the ascent/descent position of the first tray 81.

A protrusion is provided at an end of the first tray 81 close to the post-processing section 5. This protrusion engages with a groove, which is provided for the post-processing section 5 and extends long in the vertical direction, and is slidable in the groove.

The tray 8 is provided with an ejection detection section (not shown) for detecting the ejection of ejected recording sheets. As the ejection detection section, for example, a weight sensor or a mechanical detection sensor for detecting the presence/absence of recording sheets may be used.

### [Configuration of Control Section 90]

FIG. 7 is a function block diagram showing main parts of a control section 90 that accommodates a circuit substrate that controls the image formation process by the image processing apparatus 1 and an interface substrate that receives image data from an outside device.

As shown in FIG. 7, the control section 90 is constructed of, centered on a CPU 911, which is a central processing unit, an image information reception section 912, a document reading section 913, an image processing section 914, an operation section (input/display section) 915, a drive section 916, a sheet feeding section 917, a printing section 918, a sheet ejection section 919, a post-processing section 920 and a temperature control section 921. Furthermore, the control section 90 is also provided with a communication section 922, a hard disk (HD) 923, a management section 924 and a shifter mechanism 925.

The operation section 915 has an input section provided with various input keys and a display section such as LCD. The input section receives operations of the apparatus and input conditions as input. The display section displays input conditions or the like.

Here, the “input conditions” include stapling conditions such as stapling position information with respect to a recording sheet, staple orientation information with respect to the recording sheet and information on the number of recording sheets bound as one set, and printing conditions such as basis weight information of the recording sheet, recording sheet size information, recording sheet orientation information and information on the number of recording sheets for image forming.

The control section 90 monitors operations of the respective sections constituting the image processing apparatus 1 and controls the entire apparatus based on input conditions so that the image processing apparatus 1 performs accurate operations.

The communication section 922 controls communication with an outside terminal such as a personal computer installed on the network.

The hard disk 923 functions as image data storing means for storing image data inputted from the respective input means (input path: each mode mounted as the digital image processing apparatus, for example, scanner, facsimile, network). The hard disk 923 can be configured as a storing apparatus provided with a magnetic storage medium.

The management section 924 manages at least information necessary to control the respective sections of the control section 90. When the post-processing apparatus 1 is incorporated in the image processing apparatus and used, image data of a document read by the document reading section 913 is outputted from the image processing section 914 as a duplicate.

More specifically, the document reading section 913 is provided with a CCD. The document reading section 913 can electronically read an image of a document set at a reading position. The image data of the read document is completed as an output image on a volatile memory and stored temporarily in the hard disk 923. When there is a plurality of documents, the reading and storing operations are repeated. The image data stored in the hard disk 923 is then sequentially read at appropriate timing based on the processing mode instructed by the operation section 915 and sent to the volatile memory. The image data is then transferred from the memory to the printing section 918 in accordance with the timing of writing to the printing section 918.

Also when a plurality of copies of the read image data are printed, the image data are stored in the hard disk 923 in page units as the output images, sent from the hard disk 923 to the volatile memory according to the output mode, and repeatedly transferred to the printing section 918 the number of times corresponding to the number of output copies in accordance with the writing timing.

When the image processing apparatus 1 is used as a printer, the image data received by the communication section 922 is outputted from the image processing section 914 via the memory or the like.

The communication section 922 is connected to the network via a communication cable and receives image data from a device of a personal computer as an outside terminal connected on the network. The image data received by the communication section 922 is sent to the memory in page units as image data to be outputted and temporarily stored in the hard disk 923. The image data is then sent from the hard disk 923 to the volatile memory again and transferred to the printing section 918 in the same way as in the case where the image processing apparatus 1 is used as a copier.

When the image processing apparatus 1 is used as a network scanner, image data of a document read by the document reading section 913 can be transmitted from the communication section 922 to an arbitrary personal computer as an outside terminal via the network. Here, the image of the document is also electronically read using a CCD provided for the document reading section 913. The image data of the read document is completed as an output image on the volatile memory and temporarily stored in the hard disk 923. The image data is sent from the hard disk 923 to the volatile memory again and transmitted from the communication section 922 to the destination after establishing communication with the destination instructed via the operation section 915.

In addition to the network, the communication section 922 is connected to a telephone line, and also when the image processing apparatus 1 is used as a facsimile apparatus, similar operations are performed and document images can be transmitted and received to/from an outside communication apparatus.

The present embodiment has explained the image processing apparatus 1 provided with the hard disk 923 as a storing apparatus that temporarily saves image data, but the present invention is not limited thereto, and the present invention is likewise applicable to a case where the image processing apparatus 1 is provided with a non-volatile memory capable of storing stored image data even when removed from the apparatus body, memory with a backup function and other storage apparatuses (media) using a magnetic storage medium.

The respective components of the image processing apparatus 1 are controlled by the control section 90. The control section 90 monitors operation instructions from the input section of a tablet and key group provided for the operation section 915 and also appropriately guides and displays information on a state of the digital image processing apparatus and information to be reported to the user via the display section.

The management section 924 manages information on the respective components managed by the control section 90 and the control section 90 controls operations of the entire image processing apparatus based on the information.

The control section 90 is provided with an input condition changing function that calculates the load capacity of recording sheets from input conditions about the tray 8 on which the stapling processed recording sheets are loaded, judges whether or not the load capacity is equal to or greater than a maximum load capacity and changes the input conditions when the calculated load capacity is equal to or greater than the maximum load capacity.

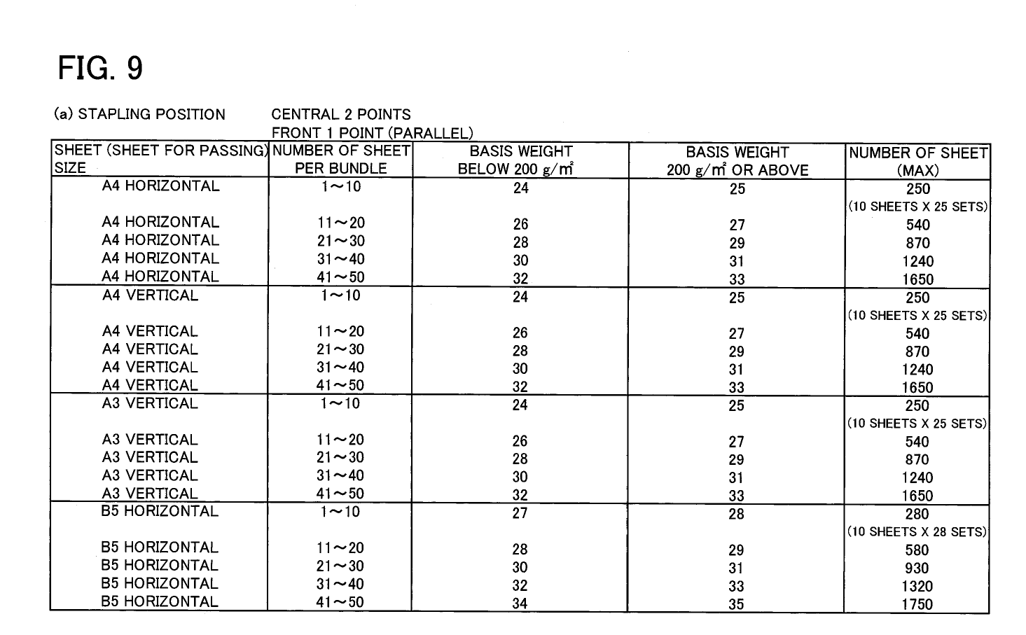

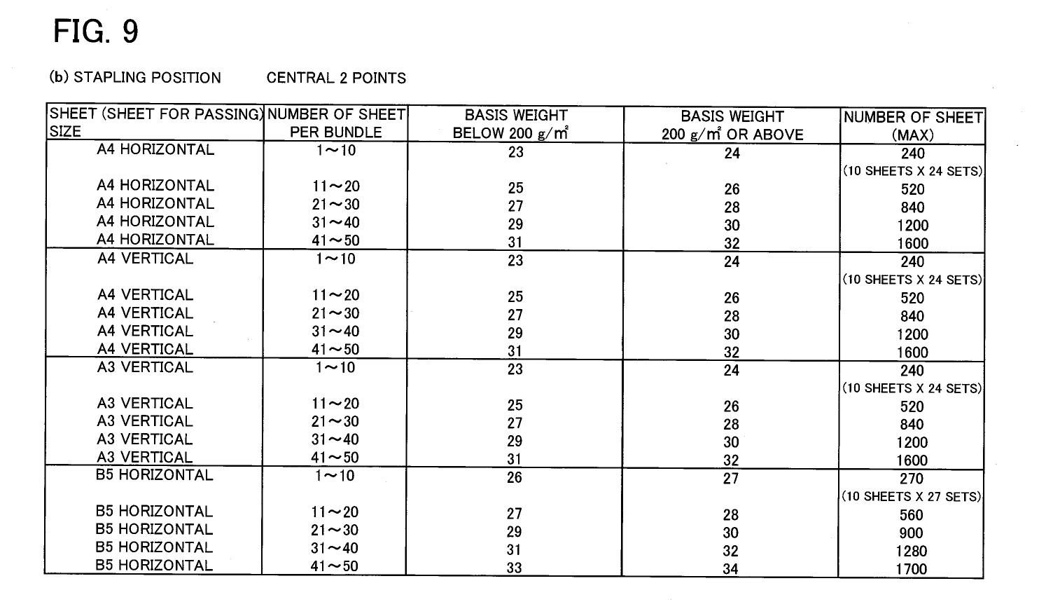

More specifically, the hard disk 923 stores a management table that stores a maximum load capacity of the tray 8 based on the stapling condition (information on stapling positions with respect to the recording sheet, staple orientation information with respect to recording sheet, information on the number of recording sheets bound as one set) as shown in FIG. 9 to FIG. 12 and printing conditions (basis weight information of recording sheets, size information of the recording sheets, orientation information of the recording sheets, information on the number of recording sheets on which images are formed).

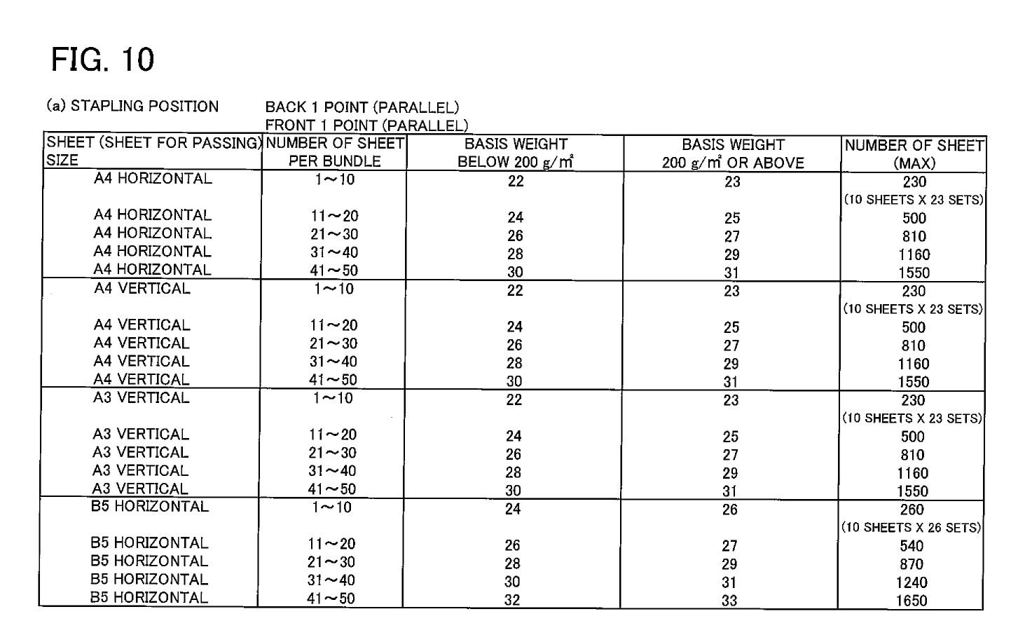

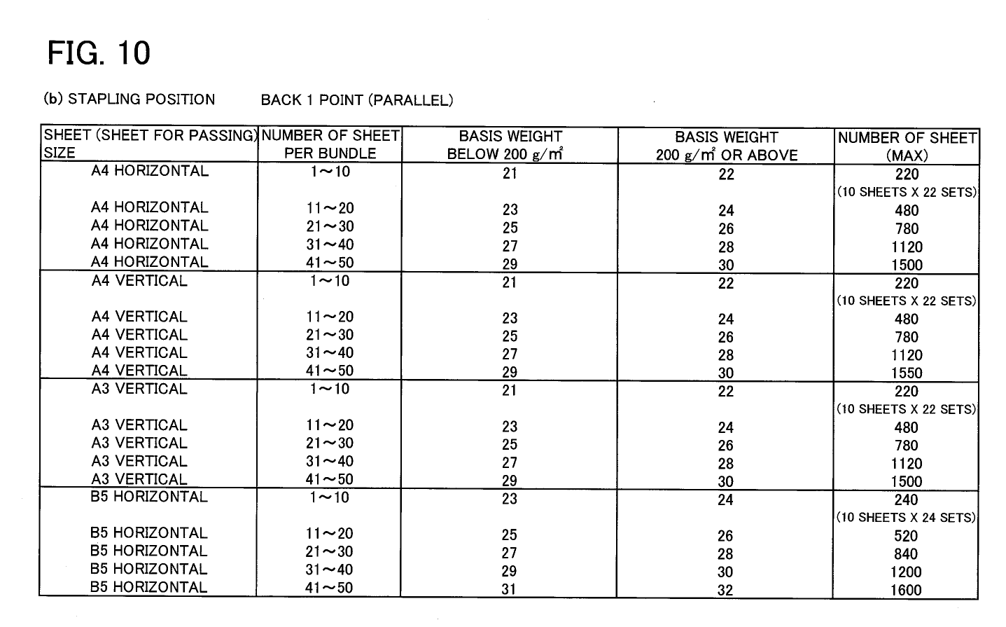

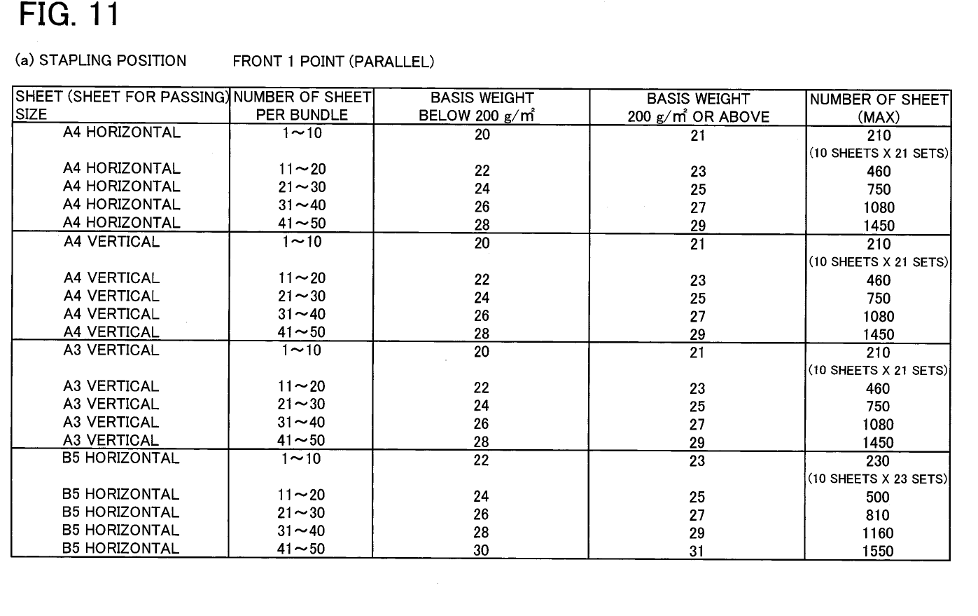

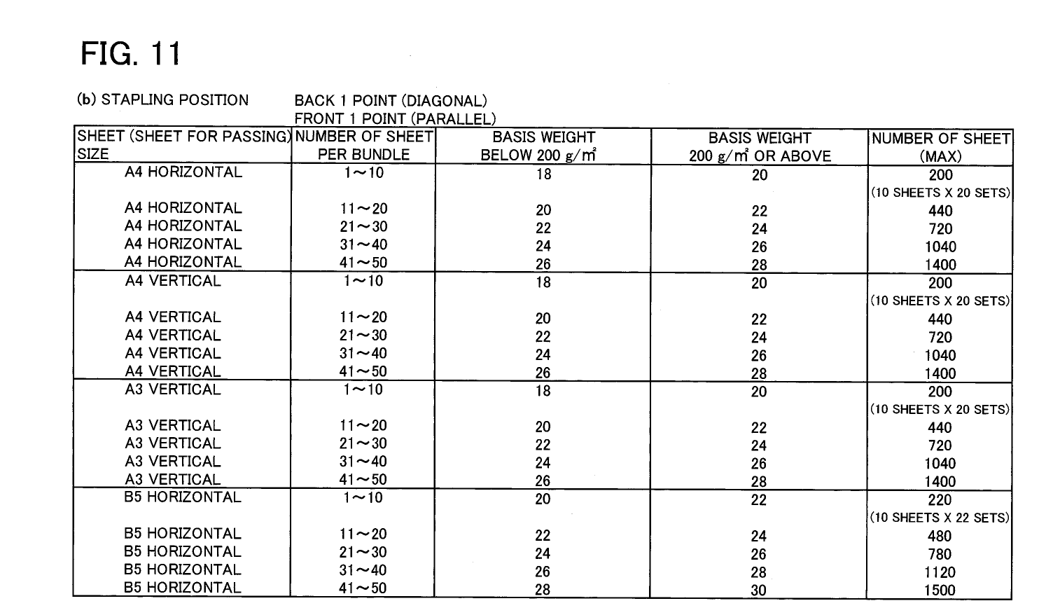

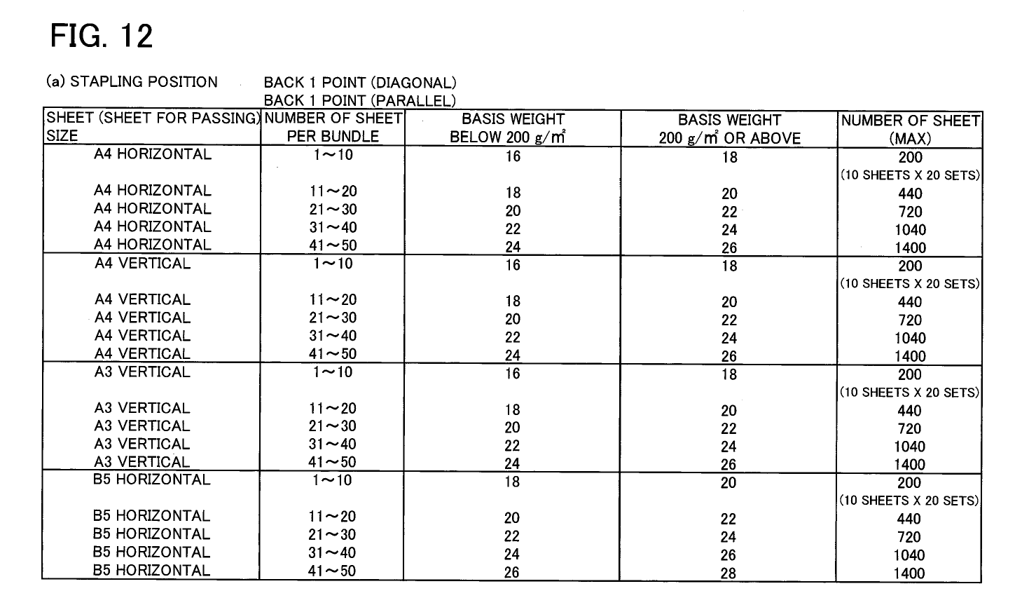

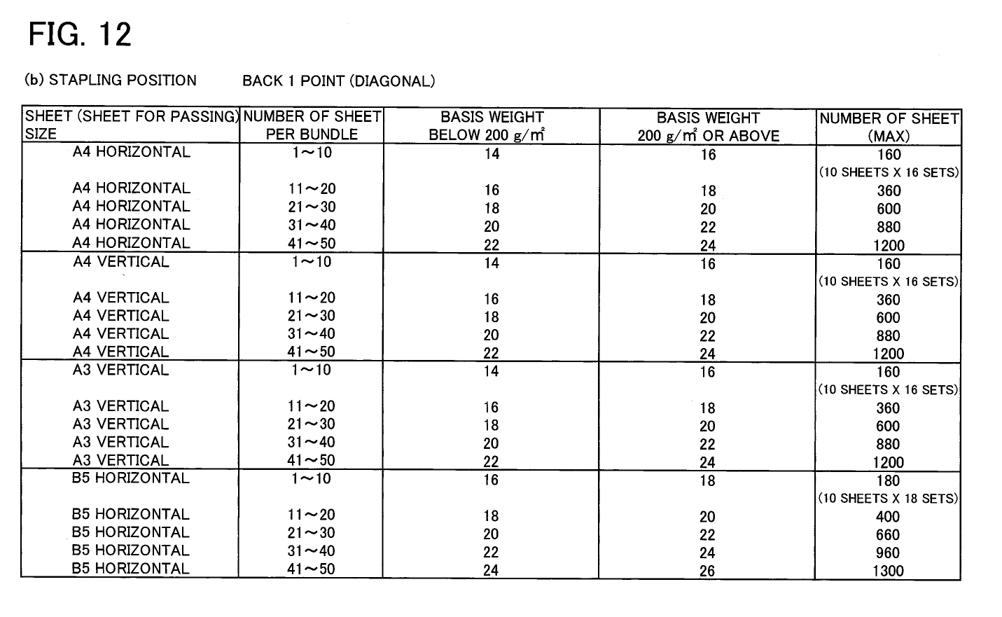

As shown in FIG. 9 to FIG. 12, the management table stores the maximum load capacity of the tray 8 according to the position information of staples. More specifically, FIG. 9(a) shows the table storing the maximum load capacity of the tray 8 when there is a mixture of cases where the stapling positions are central 2 points and where the stapling position is front 1 point (parallel). FIG. 9(b) shows the table storing the maximum load capacity of the tray 8 where the stapling positions are central 2 points. FIG. 10(a) shows the table storing the maximum load capacity of the tray 8 where there is a mixture of cases where the stapling position is back 1 point (parallel) and where the stapling position is front 1 point (parallel). FIG. 10(b) shows the table storing the maximum load capacity of the tray 8 where the stapling position is back 1 point (parallel). FIG. 11(a) shows the table storing the maximum load capacity of the tray 8 when the stapling position is front 1 point (parallel). FIG. 11(b) shows the table storing the maximum load capacity of the tray 8 when there is a mixture of cases where the stapling position is back 1 point (diagonal) and where the stapling position is front 1 point (parallel). FIG. 12(a) shows the table storing the maximum load capacity of the tray 8 when there is a mixture of cases where the stapling position is back 1 point (diagonal) and where the stapling position is back 1 point (parallel). FIG. 12(b) shows the table storing the maximum load capacity of the tray 8 where the stapling position is back 1 point (diagonal).

However, as shown in FIG. 9 to FIG. 12, the number of loadable recording sheets (thin sheets) having a basis weight of below 200 g/m² is smaller than the number of loadable recording sheets (thick sheets) having a basis weight of 200 g/m² or above.

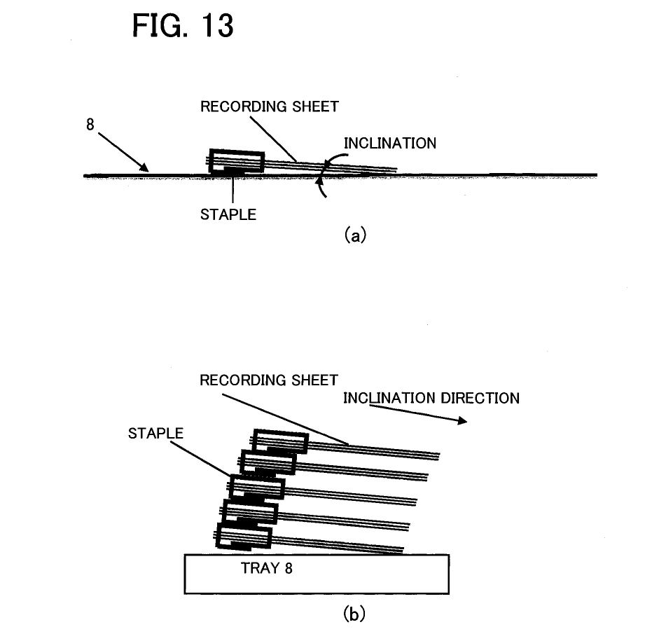

This is because there is a tendency that the height difference between the folded part of staple when staples of the same length are applied and the surface of the recording sheet of recording sheets (thin sheets) having a basis weight of below 200 g/m² is greater than that of recording sheets (thick sheets) having a basis weight of 200 g/m² or above (see FIG. 13(a)). That is, compared to the case where staples of the same length are applied to recording sheets (thick sheets) having a basis weight of 200 g/m² or above, the amount of portion of staple folded and overlapping of recording sheets (thin sheets) having a basis weight of below 200 g/m² is greater, and therefore the height difference between the folded part of staple and the surface of the sheet is greater.

Therefore, the inclination when a bundle of recording sheets is loaded on the tray 8 increases, and therefore the bundle of recording sheets is more likely to slide and fall off the tray 8 (see FIG. 13(b)). Therefore, the number of loadable recording sheets having a basis weight of below 200 g/m² (thin sheets) becomes smaller than the number of loadable recording sheets having a basis weight of 200 g/m² or above (thick sheets).

Furthermore, in FIG. 9 to FIG. 12, as for recording sheets of the same size, the maximum number of sheets loadable on the tray 8 increases as the number of recording sheets bound per set increases.

This is because as with the above-described reason, as the number of recording sheets bound per set increases, even if staples of the same length are applied, the amount of protruding portion of staple decreases. Therefore, the height difference between the folded part of staple when staples are applied and the surface of the recording sheet is diminished, the inclination when ejected sheets are stacked decreases and the frequency with which the stack may collapse decreases (see FIG. 13(b)). Therefore, the maximum number of sheets loadable on the tray 8 increases as the number of recording sheets bound per set increases.

The predetermined value regarding the number of sheets loaded on the tray 8 is determined based on the stapling condition, number of ejected sheets, size of recording sheets and basis weight. The contents of the management tables in FIG. 9 to FIG. 12 are merely examples and the present invention is not limited thereto.

The control section 90 calculates the load capacity of recording sheets loaded on the tray 8 from the input conditions inputted from the operation section 915 or the like. The control section 90 extracts the maximum load capacity of the tray 8 from the management table based on the input conditions inputted from the operation section 915 or the like. The control section 90 compares the extracted maximum load capacity with the calculated load capacity and starts the input condition changing function when the calculated load capacity is equal to or greater than the maximum load capacity.

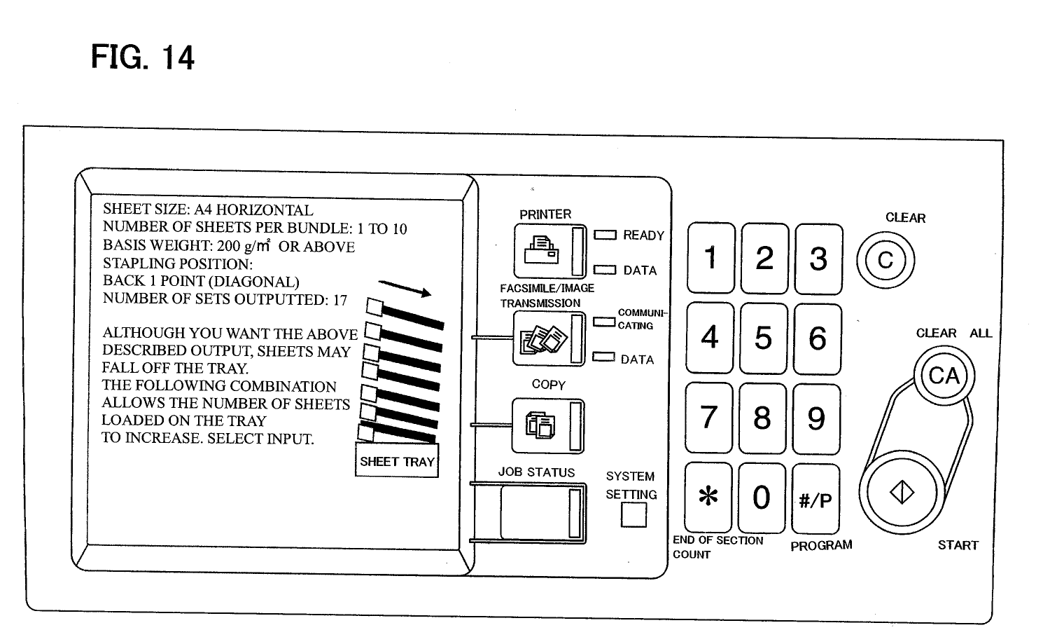

For example, when judging that the calculated load capacity is equal to or greater than the maximum load capacity, the control section 90 informs the user that the processed recording sheets cannot be loaded on the tray 8 (see FIG. 14). The control section 90 gradually extracts a plurality of different input conditions with smaller variations from the contents of the input conditions initially desired by the user from the management table.

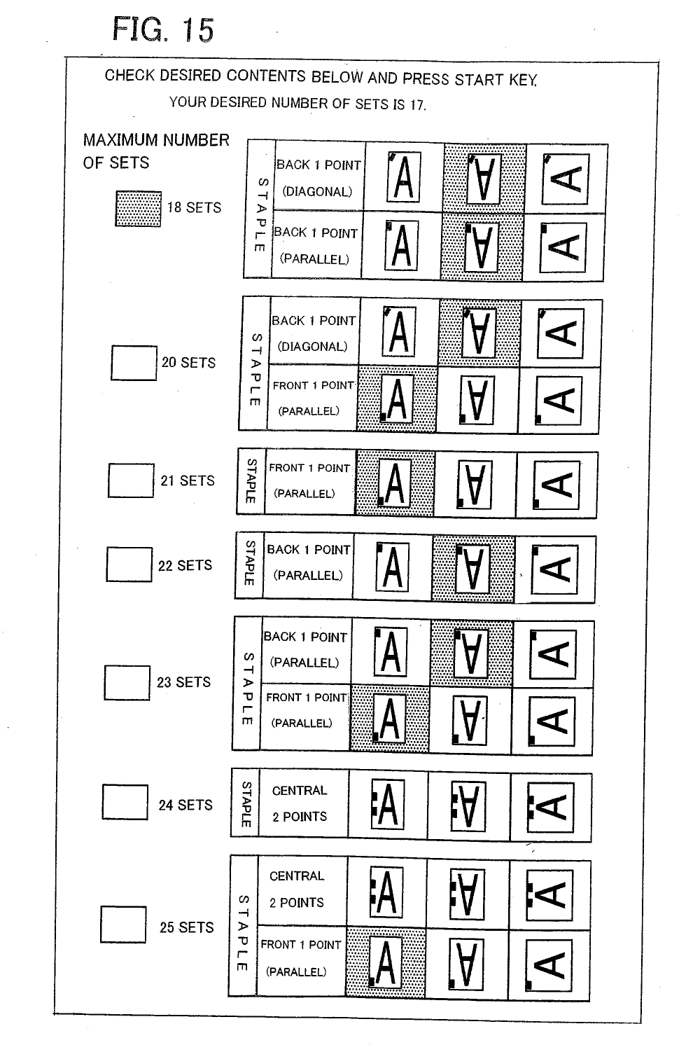

The control section 90 lists the extracted input conditions, displays the list on the display section and informs the list to the user (see FIG. 15).

Alternatively, the control section 90 communicates from the communication section 922 with an outside terminal and informs the user of the list.

The user selects a desired condition from the displayed list. The control section 90 changes the condition to the selected condition and starts processing.

More specifically, when, for example, the user selects a recording sheet of size A4 horizontal, stapling position of back 1 point (diagonal), the number of sheets per set of 5, basis weight of 200 g/m² or more and the number of recording sheets subjected to single-side printing of 17 as the input conditions, the control section 90 checks whether or not sheets can be loaded on the tray 8 based on the input conditions.

As shown in FIG. 12(b), the maximum load capacity of the tray 8 is 16. Therefore, in the case of the above-described input conditions, the maximum load capacity of the tray 8 is exceeded, and the control section 90 judges that the load capacity is equal to or greater than the maximum load capacity. The control section 90 then attaches primary importance to a new input condition with fewer variations to the input conditions initially desired by the user, that is, the stapling position of back 1 point (diagonal) desired by the user in the present embodiment, and informs the user of a list of new input conditions extracted using the stapling position as a reference.

For example, as shown in FIG. 15, a list of input conditions of different maximum numbers of sheets loadable on the tray 8 is informed using the stapling position of back 1 point (diagonal) as a reference.

More specifically, when the stapling position on a recording sheet is assumed to be only back 1 point (diagonal), an input condition that the number of recording sheets that can be ejected is 16 is informed. As other cases, changes are made so as to obtain:
(a) an input condition that the number of recording sheets that can be ejected is 18 (back 1 point (diagonal): 16 sheets, back 1 point (parallel): 2 sheets) when the stapling positions on a recording sheet are assumed to be a mixture of back 1 point (diagonal) and back 1 point (parallel);
(b) an input condition that the number of recording sheets that can be ejected is 20 (back 1 point (diagonal): 16 sheets, front 1 point (parallel): 4 sheets) when the stapling positions on a recording sheet are assumed to be a mixture of back 1 point (diagonal) and front 1 point (parallel);
(c) an input condition that the number of recording sheets that can be ejected is 21 when the stapling position on a recording sheet is assumed to be only front 1 point (parallel);
(d) an input condition that the number of recording sheets that can be ejected is 22 when the stapling position on a recording sheet is assumed to be only back 1 point (parallel);
(e) an input condition that the number of recording sheets that can be ejected is 23 (back 1 point (parallel): 22 sheets, front 1 point (parallel): 1 sheet) when the stapling position on a recording sheet is assumed to be a mixture of back 1 point (parallel) and front 1 point (parallel);
(f) an input condition that the number of recording sheets that can be ejected is 24 when the stapling position on a recording sheet is assumed to be only central 2 points;
(g) an input condition that the number of recording sheets that can be ejected is 25 (central 2 points: 24 sheets, front 1 point (parallel): 1 sheet) when the stapling position on a recording sheet is assumed to be a mixture of central 2 points and front 1 point (parallel); and these input conditions are sequentially informed. Alternatively, these input conditions are listed and informed.

The user selects a desired input condition from the list and the control section 90 starts processing based on the selected condition. This allows all recording sheets to be loaded on the tray 8. This makes it possible to reduce the number of operations of removing processed recording sheets from the tray 8.

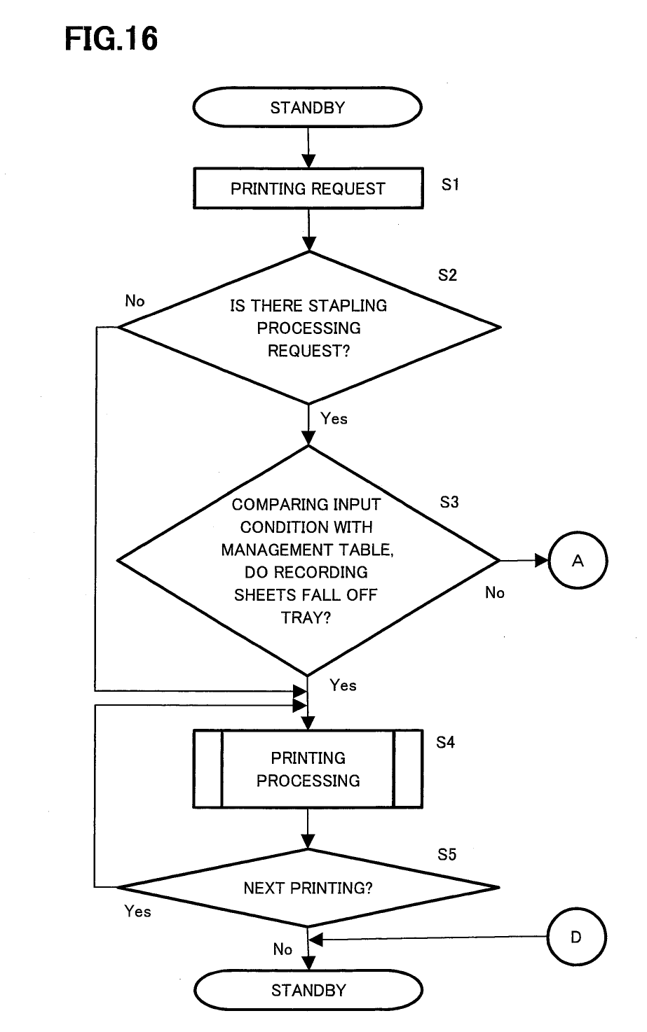

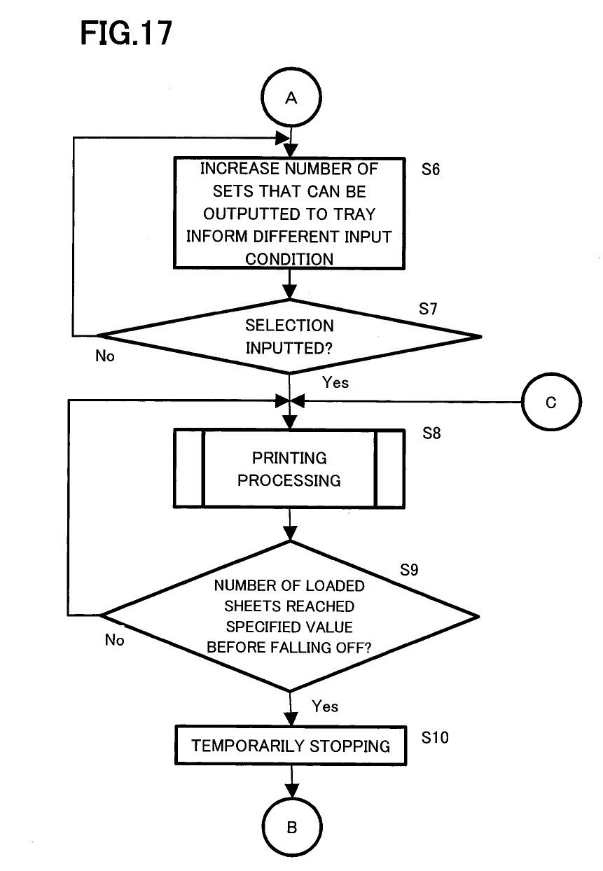

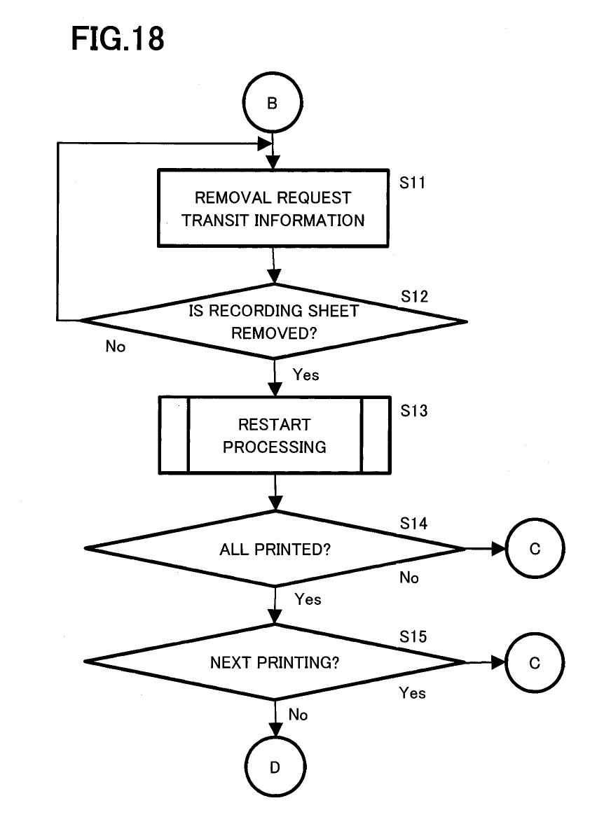

Next, the processing operation by the control section 90 at the time of a printing request will be explained with reference to FIG. 16 to FIG. 18.

When input conditions of various printing contents (size of recording sheet, type of basis weight, stapling position, number of ejected sheets, presence/absence of single-side/double-side printing) are set and a printing request is made (S1), the control section 90 checks whether or not there is a stapling processing request for the recording sheets (S2).

When there is a stapling processing request (Yes in S2), the control section 90 judges whether or not the processed recording sheet falls off the tray 8 in comparison with the management table (S3).

Upon judging that the sheet does not fall off the tray 8 (Yes in S3), the control section 90 starts printing processing based on the input condition inputted (S4), performs printing processing and stapling processing to the last and loads the printed recording sheet on the tray 8 (S5). When the processing ends, the control section 90 checks whether or not there is a next printing request and if there is no printing request, the system enters a standby state.

When there is no stapling processing request (No in S2), the control section 90 starts the printing processing as is (S4) and performs printing processing to the last (S5). When the printing ends, the control section 90 checks whether or not there is a next printing request and if there is no printing request, the system returns to the standby state.

In S3, when a comparison is made with the management table and if there is an input condition that the recording sheet falls off the tray 8, the control section 90 extracts an optimal input condition from the management table to increase the number of sheets that can be outputted to the tray 8 and displays the list (S6).

Although the present embodiment adopts the mode in which conditions are displayed starting with a condition involving fewer variations from an input condition desired by the user, the present invention is not limited to this.

The user selects any one of the input conditions displayed. The control section 90 checks the selected input condition from the displayed input conditions (S7). When the input condition is not selected, the control section 90 returns to S6 and displays a different input condition.

After checking the contents of the input condition (number of recording sheets to be ejected) included in the input condition, the control section 90 performs printing processing and stapling processing (S8).

The control section 90 performs printing. Printed recording sheets are ejected into the tray 8. The control section 90 checks the number of recording sheets ejected into the tray 8 (checks the number of ejected sheets calculated by calculation means) and judges whether or not the number of sheets ejected into the tray 8 has reached the number of recording sheets to be printed. To judge whether or not the number of sheets ejected has reached the number of recording sheets to be printed, the number of recording sheets to be printed is stored in, for example, a memory (not shown) for temporary storage and calculated in comparison with the number of sheets ejected calculated about the tray 8.

When the number of sheets ejected has not reached the number of recording sheets to be printed, the control section 90 continues the processing until the number of sheets ejected reaches the number of recording sheets to be printed (S8). When the number of sheets ejected reaches the number of recording sheets to be printed, the control section 90 checks whether or not there is a next printing request, and if there is no printing request, the system returns to the standby state.

The control section 90 also checks whether or not the number of sheets ejected has reached the maximum load capacity of the tray 8 (S9). When the number of sheets ejected has reached the maximum load capacity, the control section 90 continues the processing until the number of sheets ejected has reached the maximum load capacity (S8).

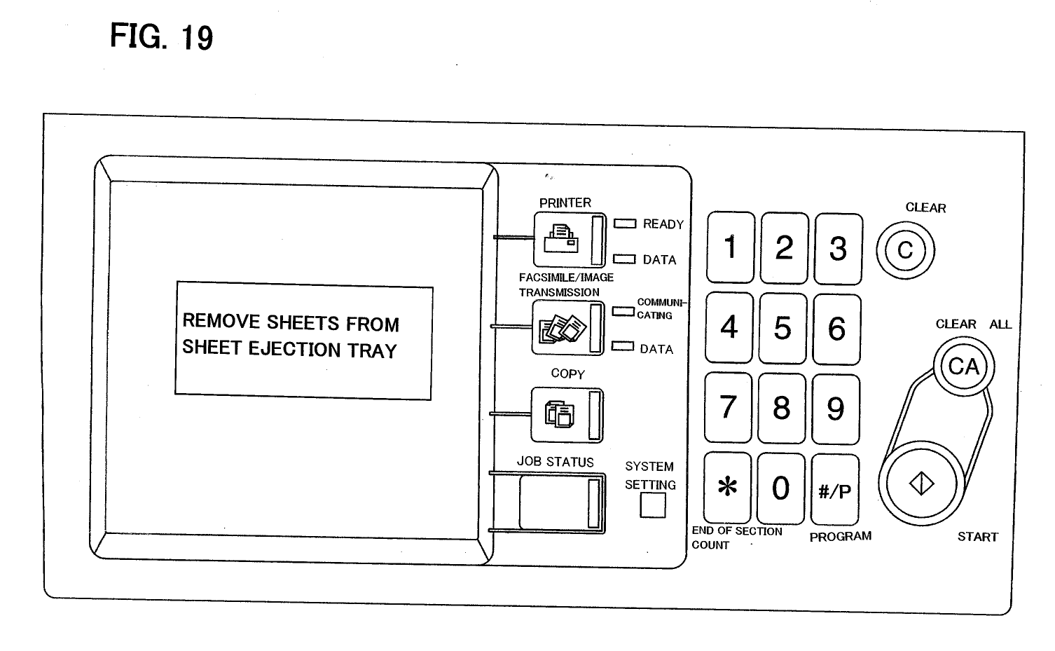

When the number of sheets ejected has reached the maximum load capacity, the control section 90 temporarily stops the processing (S10). The control section 90 then informs the user so as to remove processed recording sheets from the tray 8 as shown in FIG. 19 (S11).

The control section 90 detects whether or not the ejected recording sheets have been removed from the tray 8 through the ejection detection section (S12).

Until the ejection of the recording sheets from the tray 8 is detected, the control section 90 continues to inform the user so as to remove the recording sheets (S11). When the ejection of the recording sheets from the tray 8 is detected, the control section 90 restarts the processing (S13).

The control section 90 checks whether or not the processing has ended (S14). When the entire processing has not ended, the control section 90 returns to S8 again and continues processing. The control section 90 repeats the processing from S8 to S14 until the entire processing ends.

When the entire processing ends (Yes in S14), the control section 90 checks whether or not there is a next printing request (S15). When the next printing request exists, the control section 90 repeats the processing from S8 to S15 based on the input conditions according to the printing request. When there is no printing request, the system returns to the standby state.

As described above, according to the present invention, it is possible to load recording sheets into the tray 8 most effectively and reduce the frequency with which recording sheets subjected to post-processing are ejected from the tray 8. Therefore, it is possible to improve the operating efficiency and reliably prevent processed recording sheets from falling off.

Furthermore, when recording sheets are ejected to each tray 8, the control section 90 can perform offset processing. For example, the control section 90 performs offset processing according to stapling positions. That is, the control section 90 prevents stapling positions from overlapping with each other when sheets are loaded. More specifically, when the stapling positions are central 2 points, the offset processing realizes offset in a direction perpendicular to the sheet ejection direction of recording sheets. In this case, sheets are loaded alternately or loaded by being shifted one by one in one direction in which sheets are offset. This makes it possible to increase the maximum load capacity of the tray 8.

It goes without saying that the present invention is not limited to the above described embodiment and many corrections and modifications can be added to the above described embodiment within the scope of the present invention. A case has been explained in the present embodiment where when the number of recording sheets ejected is equal to or greater than the maximum load capacity of the tray, an input condition having different staple orientation, recording sheet orientation and basis weight with reference to the stapling position with respect to the recording sheet is extracted from the input conditions, but the present invention is not limited thereto. For example, a different input condition may also be extracted with reference to any one of items of stapling information such as staple orientation, recording sheet size and recording sheet orientation.

According to the present embodiment, staples of the same length are used and recording sheets are bundled, but the present invention is not limited thereto, and, for example, a plurality of types of staple may be provided and the lengths of staples may be changed so that sheets can be loaded on the tray. In this case, it is possible to prevent folded parts of staples from overlapping with each other, thereby suppress the inclination of the surface of recording sheets from the tray and increase the load capacity.

According to the present embodiment, when the number of desired recording sheets ejected exceeds the maximum load capacity of the tray, new input conditions are informed to the user and the user selects one input condition from the informed conditions, but the present invention is not limited thereto. For example, the control section may select an input condition remarkably similar to the input conditions from the user and automatically execute the condition. In this case, the user needs to preset criteria based on which the control section selects the condition.

When extracting different input conditions, the present embodiment extracts different input conditions with reference to stapling conditions, but the present invention is not limited thereto and input conditions may also be extracted with reference to conditions that allow more sheets to be loaded on the tray.

When there is a mixture of a plurality of stapling conditions, the present embodiment intends to maximize the number of sheets to be printed based on stapling conditions previously inputted by the user and complement the number of remaining sheets with other stapling conditions, but the present invention is not particularly limited thereto and those numbers of sheets may be equalized with a plurality of stapling conditions.

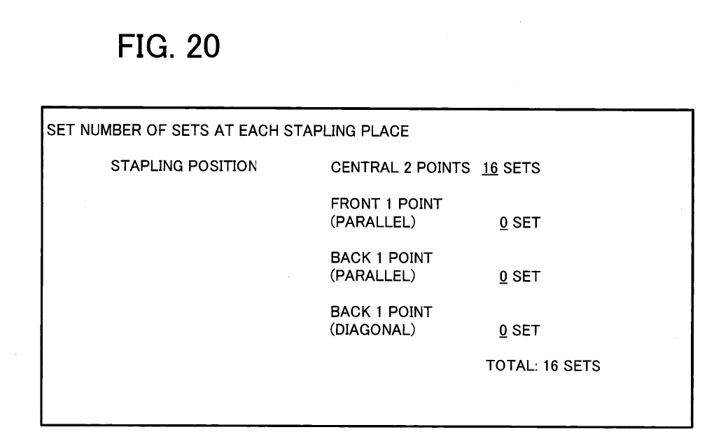

According to the present embodiment, when the number of desired recording sheets exceeds the maximum load capacity of the tray, the control section creates new input conditions based on an input condition inputted by the user, but the present invention is not particularly limited thereto. For example, as shown in FIG. 20, the user may set the number of sheets required for stapling from the operation section. This makes it possible to increase also the number of sheets loadable on the tray, perform stapling processing on only a number of sheets really required by the user and thereby prevent useless stapling processing from being performed.

According to the present embodiment, when the number of desired recording sheets exceeds the maximum load capacity of the tray, the control section performs processing based on an input condition selected from new input conditions created based on the input conditions inputted by the user, but the present invention is not limited thereto. For example, an item of unchanged processing such as “no change” or “output as is” may be provided in a list and the-control section may perform output without changing any input conditions when the user selects the item. Alternatively, when the user operates a start button provided for the operation section without selecting any new input conditions from the displayed list, the control section may perform output without changing the input conditions.

What is claimed is:

1. A post-processing apparatus comprising:
a post-processing section that performs stapling processing based on an input condition;
a tray on which the stapling processed recording sheets are placed; and
a control section that controls the post-processing section,
wherein the control section sets a maximum load capacity within which the recording sheets will not fall off the tray according to the input condition, calculates a load capacity of the recording sheets from the input condition, judges whether or not the load capacity is equal to or greater than the maximum load capacity and changes the input condition when the load capacity is equal to or greater than the maximum load capacity.

2. The post-processing apparatus according to claim 1, wherein when changing the input condition, the control section creates different input conditions so that more recording sheets can be loaded on the tray.

3. The post-processing apparatus according to claim 2, wherein the input condition includes position information of staples with respect to a recording sheet, and
the control section changes the input condition based on the position information.

4. The post-processing apparatus according to claim 3, wherein the control section changes stapling positions with respect to the recording sheet.

5. The post-processing apparatus according to claim 2, wherein the input condition includes information on the number of recording sheets on which images are formed and information on the number of recording sheets to be bound per set, and
the control section changes the input condition based on the information on the number of sheets and the information on the number of sheets to be bound.

6. The post-processing apparatus according to claim 2, wherein the input condition includes size information of the recording sheets, and
the control section changes the input condition based on the size information.

7. The post-processing apparatus according to claim 2, further including a display section that displays the input condition,
wherein the control section causes the display section to display a changed input condition and executes processing based on the selected input condition.

8. The post-processing apparatus according to claim 2,
wherein the apparatus is enabled to communicate with an outside terminal, and
the control section informs of the changed input condition the outside terminal to which input information is inputted and executes processing based on the selected input condition.

9. The post-processing apparatus according to claim 1,
wherein the control section controls the post-processing section so that recording sheets are offset and loaded on the tray.
